(19) United States
(12) Patent Application Publication
(10) Pub. No.: US 2023/0160703 A1
(43) Pub. Date: May 25, 2023

(54) SYSTEMS AND METHODS FOR DETERMINING A VEHICLE BOARDING SCORE

(71) Applicant: HERE GLOBAL B.V., Eindhoven (NL)

(72) Inventors: JEROME BEAUREPAIRE, BERLIN (DE); Gianpietro Battistutti, Berlin (DE)

(21) Appl. No.: 17/535,386

(22) Filed: Nov. 24, 2021

(51) Int. Cl. G01C 21/34

(52) U.S. Cl. CPC G01C 21/343; G01C 21/3492; G01C 21/3461

(57) ABSTRACT

Systems and methods for determining a vehicle boarding score are provided. For example, a method for determining a vehicle boarding score includes receiving traffic data corresponding to a vehicle along a route. The route includes one or more stops for boarding the vehicle. The method also includes analyzing the traffic data along the route. The method also includes based on the analysis, determining a vehicle boarding score for boarding the vehicle at the one or more stops.

### TECHNICAL FIELD

The present disclosure relates generally to transportation systems, and more specifically to systems and methods for determining a vehicle boarding score.

### BACKGROUND

Many cities all over the world have successfully implemented public transportation systems which are widely used by people. Regular users of a public transportation system may rely on the system for commuting to work or school. Others may use it to meet up with friends, attend an event, or travel in general from one location to another. Despite the advantages that come from having access to a mass transit system, there are challenges that individuals will encounter when attempting to use the system as well. In some instances, it may be difficult to gauge whether an individual will arrive at a location for boarding a vehicle prior to the vehicle departing the location.

### BRIEF SUMMARY

The present disclosure overcomes the shortcomings of prior technologies. In particular, a novel approach for determining a vehicle boarding score is provided, as detailed below.

In accordance with an aspect of the disclosure, a method for determining a vehicle boarding score is provided. The method includes analyzing the traffic data along the route. The method also includes based on the analysis, determining a vehicle boarding score for boarding the vehicle at the one or more stops.

In accordance with another aspect of the present disclosure, a non-transitory computer-readable storage medium is provided. The non-transitory computer-readable storage medium includes one or more sequences of one or more instructions for execution by one or more processors of a device. The one or more instructions which, when executed by the one or more processors, cause the device to receive traffic data corresponding to a vehicle along a route. The route includes one or more stops for boarding the vehicle. The one or more instructions further cause the device to analyze the traffic data along the route. The one or more instructions further cause the device to, based on the analysis, determine a vehicle boarding score for boarding the vehicle along the route at the one or more stops. The one or more instructions further cause the device to provide for display, via the display screen, the vehicle boarding score.

In accordance with another aspect of the disclosure, an apparatus is provided. The apparatus includes a processor. The apparatus also includes a memory comprising computer program code for one or more programs. The computer program code is configured to cause the processor of the apparatus to receive traffic data corresponding to a vehicle along a route. The route includes one or more stops for boarding the vehicle. The computer program code is further configured to cause the processor of the apparatus to receive map data corresponding to a mobile device. The computer program code is further configured to cause the processor of the apparatus to analyze the traffic data, the map data, or a combination thereof. The computer program code is further configured to cause the processor of the apparatus to, based on the analysis, determine a vehicle boarding score for boarding the vehicle at the one or more stops

Also, a computer program product may be provided. For example, a computer program product comprising instructions which, when the program is executed by a computer, cause the computer to carry out the steps described herein.

In addition, for various example embodiments, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment.

For various example embodiments, the following is also applicable: a method comprising facilitating access to at least one interface configured to allow access to at least one service, the at least one service configured to perform any one or any combination of network or service provider methods (or processes) disclosed in this application.

For various example embodiments, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment, and/or at least one signal resulting from one or any combination of methods (or processes) disclosed in this application as relevant to any embodiment.

For various example embodiments, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment, and/or at least one signal resulting from one or any combination of methods (or processes) disclosed in this application as relevant to any embodiment.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages are readily apparent from the following detailed description, simply by illustrating a number of particular embodiments and implementations. The drawings and description are to be regarded as illustrative in nature, and not as restrictive.

### BRIEF DESCRIPTION OF THE DRAWINGS

The embodiments are illustrated by way of example, and not by way of limitation, in the figures of the accompanying drawings:

FIG. 1 is a diagram of a system capable of determining a vehicle boarding score, in accordance with aspects of the present disclosure;

FIG. 2 is a diagram illustrating an example scenario for determining a vehicle boarding score, in accordance with aspects of the present disclosure;

FIG. 3 is a diagram illustrating another example scenario for determining a vehicle boarding score, in accordance with aspects of the present disclosure;

FIG. 4 is a diagram illustrating another example scenario for determining a vehicle boarding score, in accordance with aspects of the present disclosure;

FIG. 5 is a diagram illustrating another example scenario for determining a vehicle boarding score, in accordance with aspects of the present disclosure;

FIG. 6 is a diagram of a geographic database, in accordance with aspects of the present disclosure;

FIG. 7 is a diagram of the components of a data analysis system, in accordance with aspects of the present disclosure;

FIG. 8 is a flowchart setting forth steps of an example process, in accordance with aspects of the present disclosure;

FIG. 9 is a flowchart setting forth steps of another example process, in accordance with aspects of the present disclosure;

FIG. 10 is a flowchart setting forth steps of another example process, in accordance with aspects of the present disclosure;

FIG. 11 is a diagram of an example computer system, in accordance with aspects of the present disclosure;

FIG. 12 is a diagram of an example chip set, in accordance with aspects of the present disclosure; and

FIG. 13 is a diagram of an example mobile device, in accordance with aspects of the present disclosure.

### DESCRIPTION OF SOME EMBODIMENTS

Examples of a method, a non-transitory computer-readable storage medium, and an apparatus for determining a vehicle boarding score are disclosed. In the following description, for the purposes of explanation, numerous specific details are set forth in order to provide a thorough understanding of the embodiments. It is apparent, however, to one skilled in the art that the embodiments may be practiced without these specific details or with an equivalent arrangement. In other instances, well-known structures and devices are shown in block diagram form in order to avoid unnecessarily obscuring the embodiments.

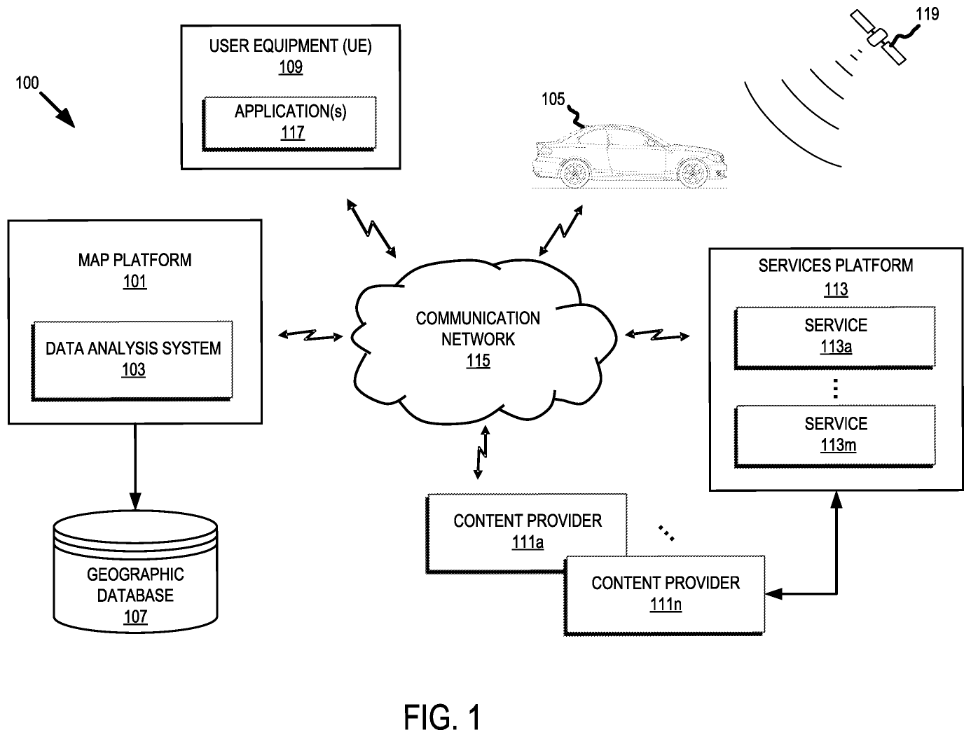

FIG. 1 is a diagram of a system 100 capable of determining a vehicle boarding score, according to one embodiment. The system 100 of FIG. 1 introduces a capability to receive traffic data corresponding to a vehicle traveling along a route. In one example, the route includes one or more stops for boarding the vehicle. In one example, the vehicle is a public transport vehicle such as a bus, train, or light rail vehicle. The system 100 can analyze traffic data along the route of the vehicle. In one example, the traffic data is based on real-time traffic data reports. In another example, the traffic data is based on a combination of real-time traffic data report and historical traffic data report. Based on the analysis, the system 100 can determine a vehicle boarding score for boarding the vehicle at the one or more stops.

Referring to FIG. 1, the map platform 101 can be a standalone server or a component of another device with connectivity to the communication network 115. For example, the component can be part of an edge computing network where remote computing devices (not shown) are installed along or within proximity of a given geographical area.

The communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, fifth generation mobile (5G) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the map platform 101 may be a platform with multiple interconnected components. The map platform 101 may include multiple servers, intelligent networking devices, computing devices, components and corresponding software for generating information for determining a vehicle boarding score or other map functions. In addition, it is noted that the map platform 101 may be a separate entity of the system 100, a part of one or more services 113a-113m of a services platform 113.

The services platform 113 may include any type of one or more services 113a-113m. By way of example, the one or more services 113a-113m may include weather services, mapping services, navigation services, travel planning services, notification services, social networking services, content (e.g., audio, video, images, etc.) provisioning services, application services, storage services, information for determining a vehicle boarding score, location-based services, news services, etc. In one embodiment, the services platform 113 may interact with the map platform 101, and/or one or more content providers 111a-111n to provide the one or more services 113a-113m.

In one embodiment, the one or more content providers 111a-111n may provide content or data to the map platform 101, and/or the one or more services 113a-113m. The content provided may be any type of content, mapping content, textual content, audio content, video content, image content, etc. In one embodiment, the one or more content providers 111a-111n may provide content that may aid in determining a vehicle boarding score according to the various embodiments described herein. In one embodiment, the one or more content providers 111a-111n may also store content associated with the map platform 101, and/or the one or more services 113a-113m. In another embodiment, the one or more content providers 111a-111n may manage access to a central repository of data, and offer a consistent, standard interface to data.

In one embodiment, the vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. In another example, the vehicle 105 may be an autonomous vehicle. The autonomous vehicle may be a manually controlled vehicle, semi-autonomous vehicle (e.g., some routine motive functions, such as parking, are controlled by the vehicle), or an autonomous vehicle (e.g., motive functions are controlled by the vehicle without direct driver input). In one example, the vehicle 105 may be a public transport vehicle such as a bus, a train, or a light rail vehicle.

The autonomous level of a vehicle can be a Level 0 autonomous level that corresponds to no automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle. In one embodiment, user equipment (e.g., a mobile phone, a portable electronic device, etc.) may be integrated in the vehicle, which may include assisted driving vehicles such as autonomous vehicles, highly assisted driving (HAD), and advanced driving assistance systems (ADAS). Any of these assisted driving systems may be incorporated into the user equipment. Alternatively, an assisted driving device may be included in the vehicle.

The term autonomous vehicle may refer to a self-driving or driverless mode in which no passengers are required to be on board to operate the vehicle. An autonomous vehicle may be referred as a robot vehicle or an automated vehicle. The autonomous vehicle may include passengers, but no driver is necessary. These autonomous vehicles may park themselves or move packages between locations without a human operator. Autonomous vehicles may include multiple modes and transition between the modes. The autonomous vehicle may steer, brake, or accelerate and respond to lane marking indicators (lane marking type, lane marking intensity, lane marking color, lane marking offset, lane marking width, or other characteristics) and driving commands or navigation commands.

In one embodiment, the vehicle 105 may be an HAD vehicle or an ADAS vehicle. An HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In one embodiment, the user equipment (UE) 109 may be, or include, an embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 109 may support any type of interface with a user (e.g., by way of various buttons, touch screens, consoles, displays, speakers, “wearable” circuitry, and other I/O elements or devices). Although shown in FIG. 1 as being separate from the vehicle 105, in some embodiments, the UE 109 may be integrated into, or part of, the vehicle 105.

In one embodiment, the UE 109, may execute one or more applications 117 (e.g., software applications) configured to carry out steps in accordance with methods described here. For instance, in one non-limiting example, the application 117 may carry out steps for determining a vehicle boarding score. In another non-limiting example, application 117 may also be any type of application that is executable on the UE 109 and/or vehicle 105, such as autonomous driving applications, mapping applications, location-based service applications, navigation applications, content provisioning services, camera/imaging application, media player applications, social networking applications, calendar applications, and the like. In yet another non-limiting example, the application 117 may act as a client for the data analysis system 103 and perform one or more functions associated with determining a vehicle boarding score, either alone or in combination with the data analysis system 103.

In some embodiments, the UE 109 and/or the vehicle 105 may include various sensors for acquiring a variety of different data or information. For instance, the UE 109 and/or the vehicle 105 may include one or more camera/imaging devices for capturing imagery (e.g., terrestrial images), global positioning system (GPS) sensors or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, Light Detection and Ranging (LIDAR) sensors, Radio Detection and Ranging (RADAR) sensors, audio recorders for gathering audio data, velocity sensors, switch sensors for determining whether one or more vehicle switches are engaged, and others.

The UE 109 and/or the vehicle 105 may also include one or more light sensors, height sensors, accelerometers (e.g., for determining acceleration and vehicle orientation), magnetometers, gyroscopes, inertial measurement units (IMUs), tilt sensors (e.g., for detecting the degree of incline or decline), moisture sensors, pressure sensors, and so forth. Further, the UE 109 and/or the vehicle 105 may also include sensors for detecting the relative distance of the vehicle 105 from a lane or roadway, the presence of other vehicles, pedestrians, traffic lights, lane markings, speed limits, road dividers, potholes, and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

In some embodiments, the UE 109 and/or the vehicle 105 may include GPS, GNSS or other satellite-based receivers configured to obtain geographic coordinates from a satellite 119 for determining current location and time. Further, the location can be determined by visual odometry, triangulation systems such as A-GPS, Cell of Origin, or other location extrapolation technologies, and so forth. In some embodiments, two or more sensors or receivers may be co-located with other sensors on the UE 109 and/or the vehicle 105.

By way of example, the map platform 101, the services platform 113, and/or the one or more content providers 111a-111n communicate with each other and other components of the system 100 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6, and layer 7) headers as defined by the OSI Reference Model.

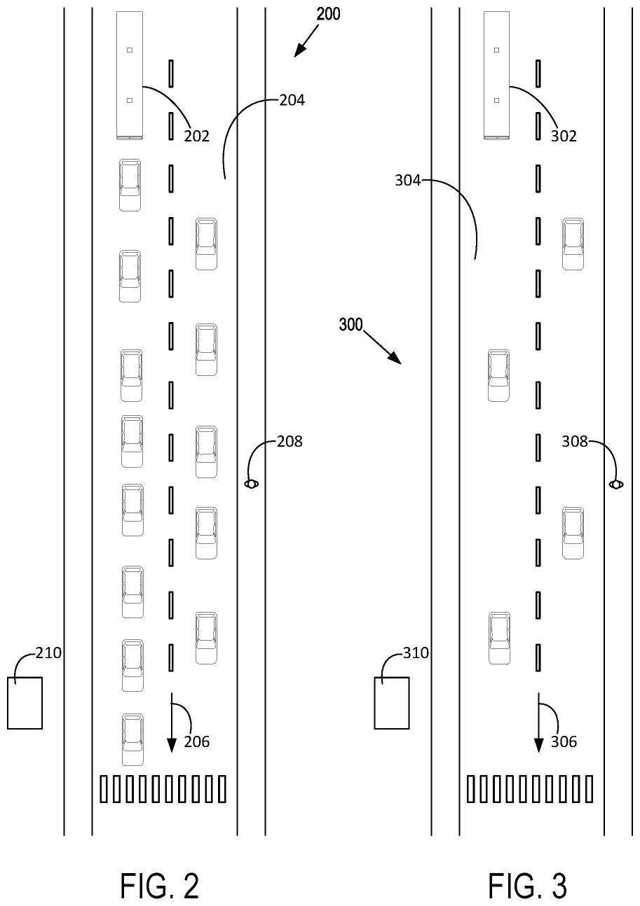

FIG. 2 is a diagram illustrating an example scenario for determining a vehicle boarding score. The scenario 200 includes a top view of a vehicle 202, a road segment 204, an individual 208, and a vehicle stop 210. As shown in FIG. 2, the vehicle 202 is traveling in a direction 206 along the road segment 204 amongst heavy traffic.

In one embodiment, the system 100 of FIG. 1 is configured to receive traffic data corresponding to a vehicle along a route. The route includes one or more stops for the boarding the vehicle. In this embodiment, the system 100 is configured to analyze the traffic data along the route. Continuing with this embodiment, the system 100 is configured to receive a request by an individual to board the vehicle at a stop of the one or more stops for boarding the vehicle. Continuing with this embodiment, the system 100 is configured to, based on the analysis and the request to board the vehicle, determine a vehicle boarding score for boarding the vehicle at the one or more stops.

In one example, the system 100 of FIG. 1 is configured to receive traffic data corresponding to the vehicle 202 along the road segment 204. In this example, the system 100 is also configured to analyze the traffic data along the road segment 204. In one example, the individual 208 may request to board the vehicle 202 at the vehicle stop 210 via a mobile device (e.g., UE 109 of FIG. 1) associated with the individual 208. Continuing with this example, the system 100 is configured to, based on the analysis and the request to board the vehicle 202, determine a vehicle boarding score for boarding the vehicle 202 at the vehicle stop 210.

In one embodiment, the system 100 may be configured to classify the vehicle boarding scores into two categories, low and high. In one example, the system 100 is configured to determine that the traffic along road segment 204 is heavier than usual based on the number of vehicles traveling along the road segment 204, as shown in FIG. 2. In this example, the system 100 is configured to determine that the vehicle boarding score for boarding the vehicle 202 (e.g., a bus) at the vehicle stop 210 (e.g., a bus stop) is high. In one example, a vehicle boarding score that is high may be based on the time that it takes the vehicle 202 to reach the vehicle stop 210 according to the traffic conditions along a route that includes the road segment 204. As shown in FIG. 2, based on the high number of vehicles along the road segment 204, the vehicle 202 may take more time than normal to reach the vehicle stop 210.

In one example, the individual 208 may access the vehicle boarding score associated with the vehicle 202 via a mobile device (e.g., UE 109 of FIG. 1) and based on seeing that the vehicle boarding score that is high, continue walking towards the vehicle stop 210 at a current pace. In this example, the system 100 may be configured to determine that the vehicle boarding score is high based on the current location of the mobile device, via receipt of the request to board the vehicle 202, associated with the individual 208, the analysis of the traffic data along the road segment 204, the location of the vehicle stop 210, and the speed and location of the vehicle 202.

In another example, the system 100 is configured to receive map data corresponding to a mobile device associated with the individual 208 and the vehicle stop 210. In one example, the system 100, based on the map data (e.g., crosswalk information, number of traffic lights, etc.), may be configured to determine an expected time of travel for reaching the vehicle stop 210 based on the current location of the individual 208. In this example, the, system 100 may be configured to determine the distance required to reach the vehicle stop 210 in addition to the average time that it takes to cross the road segment 204 based on the current location of the individual 208. Based on the analysis of the map data, the system 100 may be configured to modify the vehicle boarding score. In one example, the system 100 may be configured to decrease the vehicle boarding score from high to low based on the analysis of the map data. In one example, the system 100 may provide a notification to the individual 208, via the mobile device, that the vehicle boarding score has been modified to low and provide one or more suggested actions in response to the modification to the vehicle boarding score.

FIG. 3 is a diagram illustrating an example scenario for determining a vehicle boarding score. The scenario 300 includes a top view of a vehicle 302, a road segment 304, an individual 308, and a vehicle stop 310. As shown in FIG. 3, the vehicle 302 is traveling in a direction 306 along the road segment 304 amongst light traffic.

In one example, the system 100 of FIG. 1 is configured to receive traffic data corresponding to the vehicle 302 along the road segment 304. In this example, the system 100 is also configured to analyze the traffic data along the road segment 304. In one example, the individual 308 may request to board the vehicle 302 at the vehicle stop 310 via a mobile device (e.g., UE 109 of FIG. 1) associated with the individual 308. Continuing with this example, the system 100 is configured to, based on the analysis and the request to board the vehicle 302, determine a vehicle boarding score for boarding the vehicle 302 at the vehicle stop 310

In one example, the system 100 is configured to determine that the traffic along road segment 304 is lighter than usual based on the number of vehicles traveling along the road segment 304, as shown in FIG. 3. In this example, the system 100 is configured to determine that the vehicle boarding score for boarding the vehicle 302 (e.g., a bus) at the vehicle stop 310 (e.g., a bus stop) is low. In one example, a vehicle boarding score that is low may be based on the speed that the vehicle 302 is traveling at along a route that includes the road segment 304, according to the traffic conditions along the route. As shown in FIG. 3, due to the lack of vehicles along the road segment 304, the vehicle 302 may reach the vehicle stop 310 before the individual 308 has reached the vehicle stop 310.

In one example, the individual 308 may access the vehicle boarding score associated with the vehicle 302 via a mobile device (e.g., UE 109 of FIG. 1) and based on a vehicle boarding score that is low, the individual 308 may begin walking with a faster pace towards the vehicle stop 310. In this example, the system 100 may be configured to determine that the vehicle boarding score is low based on the current location of the mobile device, via receipt of the request to board the vehicle 302, associated with the individual 308, the analysis of the traffic data along the road segment 304, the location of the vehicle stop 310, and the speed and location of the vehicle 302.

In another example, the system 100 is configured to receive movement data corresponding to a mobile device (e.g., UE 109 of FIG. 1) associated with the individual 308. In one example, the system 100, based on the movement data, may be configured to determine an expected time of travel for reaching the vehicle stop 310 based on the current location of the individual 308 and how fast the individual 308 is moving along a path towards the vehicle stop 310. In this example, the, system 100 may be configured to determine an approximate time that it will take the individual 308 to reach the vehicle stop 310 based on the movement data. Based on the analysis of the movement data, the system 100 may be configured to modify the vehicle boarding score. In one example, the system 100 may be configured to increase the vehicle boarding score from low to high based on the analysis of the movement data. In one example, the system 100 may provide a notification to the individual 308, via the mobile device, that the vehicle boarding score has been modified to high based on the analysis of the movement data.

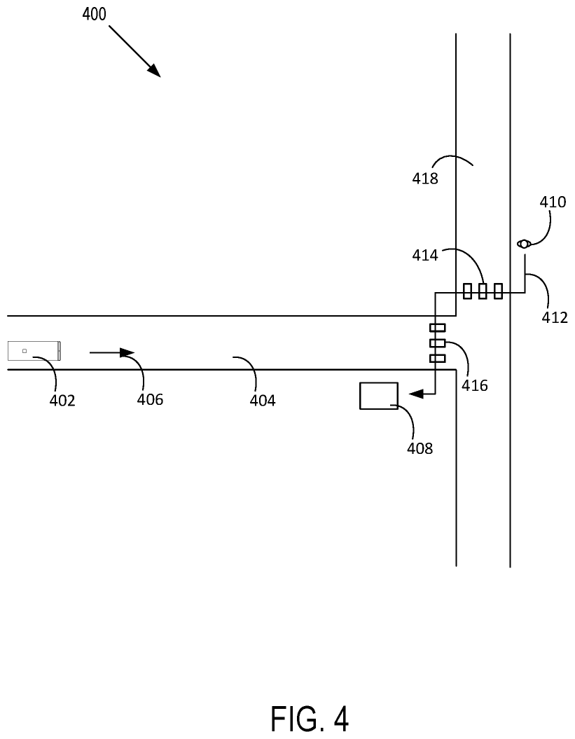

FIG. 4 is a diagram illustrating an example scenario for determining a vehicle boarding score. The scenario 400 includes a top view of a vehicle 402, a road segment 404, a vehicle stop 408, an individual 410, and a road segment 418. The road segment 404 includes a crosswalk 416. The road segment 418 includes a crosswalk 414. As shown in FIG. 4, the vehicle 402 is traveling in a direction 406 along the road segment 404.

In one embodiment, the system 100 of FIG. 1 is configured to receive traffic data corresponding to a vehicle along a route. The route includes one or more stops for the boarding the vehicle. In this embodiment, the system 100 is configured to receive map data corresponding to a mobile device. In this embodiment, the system 100 is configured analyze the traffic data, the map data, or a combination thereof. Continuing with this embodiment, the system 100 is configured to, based on the analysis, determine a vehicle boarding score for boarding the vehicle at the one or more stops. In one example, the map data includes various map elements included in one or more maps.

In one example, the system 100 of FIG. 1 is configured to receive traffic data corresponding to the vehicle 402 travelling along the road segment 404. In this example, the system 100 is also configured to receive map data corresponding to a mobile device (e.g., UE 109 of FIG. 1) associated with the individual 410. The map data includes information about the crosswalks 414 and 416. The map data also includes information about the path 412 that the individual 410 could take to reach the vehicle stop 408. Continuing with this example, the system 100 is configured to analyze the traffic data, the map data, or a combination thereof. In this example, based on the analysis, the system 100 is configured to determine a vehicle boarding score for boarding the vehicle 402 at the vehicle stop 408.

In one example, the system 100 is configured to determine that the traffic along road segment 404 is clear due to the lack of vehicles traveling along the road segment 404, as shown in FIG. 4. In this example, the system 100 is also configured to determine that the individual 410, based on a current location, should be able to travel along the path 412 and reach the vehicle stop 408 before the vehicle 402 reaches the vehicle stop 408, according to an analysis of the traffic data and the map data. In this example, the system 100 is configured to determine that the vehicle boarding score for boarding the vehicle 402 (e.g., a bus) at the vehicle stop 410 (e.g., a bus stop) is high.

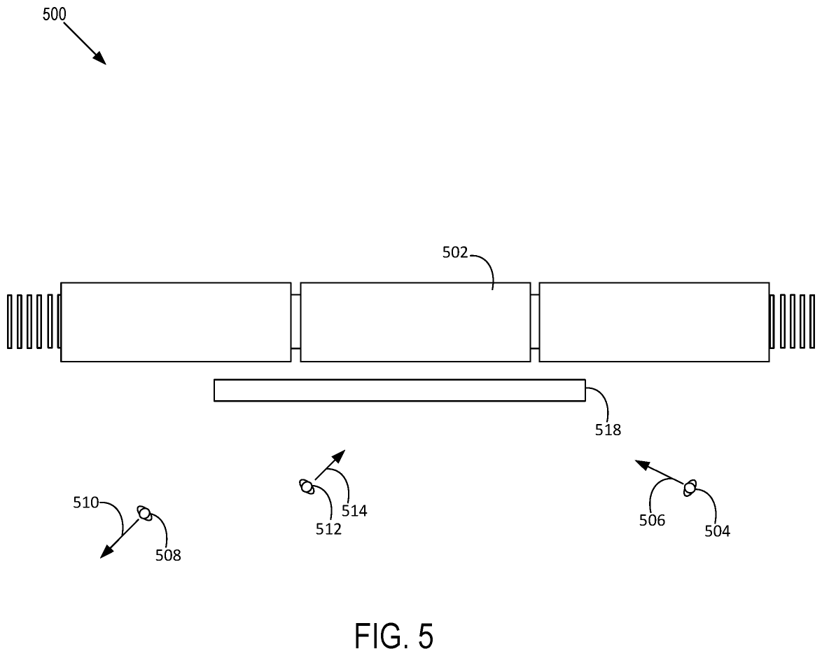

FIG. 5 is a diagram illustrating an example scenario for determining a vehicle boarding score. The scenario 500 includes a top view of a vehicle 502, an individual 504, an individual 508, and an individual 512. As shown in FIG. 5, the individual 504 is moving in a direction 506, the individual 508 is moving in a direction 510, and the individual 512 is moving in a direction 514.

In one embodiment, the system 100 of FIG. 1 is configured to receive route data corresponding to a vehicle scheduled to travel along a route that includes one or more stops for the boarding the vehicle. In this embodiment, the system 100 is configured to receive movement data corresponding to a mobile device. In this embodiment, the system 100 is configured analyze the route data, the movement data, or a combination thereof. Continuing with this embodiment, the system 100 is configured to, based on the analysis, determine a vehicle boarding score for boarding the vehicle at the one or more stops. In one example, the route data may include a timetable of arrival and departure times associated with the one or more stops for boarding the vehicle.

In one example, the system 100 of FIG. 1 is configured to receive route data corresponding to the vehicle 502 (e.g., a train) scheduled to travel along a route but currently stopped at vehicle stop 518, as shown in FIG. 5. In this example, the system 100 is also configured to receive movement data corresponding to a mobile device (e.g., UE 109 of FIG. 1) associated with the individual 504, movement data corresponding to a mobile device (e.g., UE 109 of FIG. 1) associated with the individual 508, and movement data corresponding to a mobile device (e.g., UE 109 of FIG. 1) associated with the individual 512. Continuing with this example, the system 100 is configured to analyze the route data, the movement data, or a combination thereof. In this example, based on the analysis, the system 100 is configured to determine a vehicle boarding score for boarding the vehicle 502 at the vehicle stop 518.

In one example, the system 100 is configured to determine that based on the relative position of the individuals 504, 508, and 512 to the vehicle 502 that the vehicle boarding score for boarding the vehicle 502 at the vehicle stop 518 is high. In one example, the system 100 is configured to determine that the vehicle boarding score remains high for the individual 504 moving in the direction 506 towards the vehicle 502. In this example, the system 100 is configured to determine that the vehicle boarding score also remains high for the individual 512 moving in the direction 514 towards the vehicle 502. Continuing with this example, the system 100 is configured to determine that the vehicle boarding score is subject to change based on the individual 508 continuing to move in the direction 510 away from the vehicle 502. In one example, the system 100 may provide a notification to the individual 508 that the vehicle boarding score may soon be modified to low based on the individual 508 getting farther way from the vehicle 502 while traveling away from the vehicle 502.

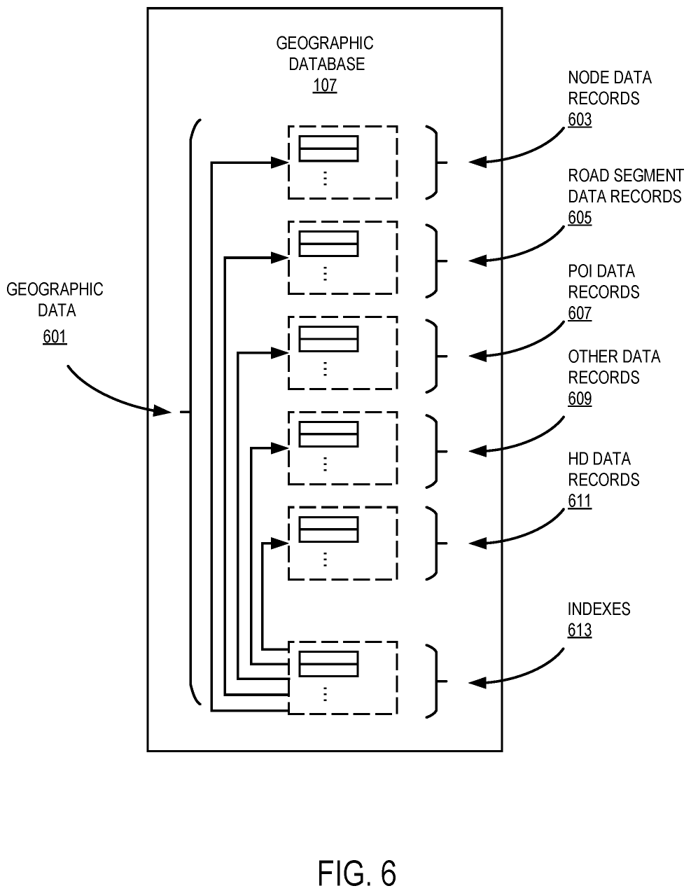

FIG. 6 is a diagram of the geographic database 107 of system 100, according to exemplary embodiments. In the exemplary embodiments, the information generated by the map platform 101 can be stored, associated with, and/or linked to the geographic database 107 or data thereof. In one embodiment, the geographic database 107 includes geographic data 601 used for (or configured to be compiled to be used for) mapping and/or navigation-related services, such as for personalized route determination, according to exemplary embodiments. For example, the geographic database 107 includes node data records 603, road segment data records 605, POI data records 607, other data records 609, HD data records 611, and indexes 613, for example. It is envisioned that more, fewer or different data records can be provided.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the geographic database 107.

“Node”— A point that terminates a link.

“Line segment”— A straight line connecting two points.

“Link” (or “edge”)— A contiguous, non-branching string of one or more line segments terminating in a node at each end.

“Shape point”— A point along a link between two nodes (e.g., used to alter a shape of the link without defining new nodes).

“Oriented link”— A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 107 follows certain conventions. For example, links do not cross themselves and do not cross each other except at a node or vertex. Also, there are no duplicated shape points, nodes, or links. Two links that connect each other have a common node or vertex. In the geographic database 107, overlapping geographic features are represented by overlapping polygons. When polygons overlap, the boundary of one polygon crosses the boundary of the other polygon. In the geographic database 107, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the geographic database 107 is presented according to a hierarchical or multi-level tile projection. More specifically, in one embodiment, the geographic database 107 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

In one embodiment, the system 100 may identify a tile by a quadkey determined based on the tile ID of a tile of the map tile grid. The quadkey, for example, is a one dimensional array including numerical values. In one embodiment, the quadkey may be calculated or determined by interleaving the bits of the row and column coordinates of a tile in the grid at a specific level. The interleaved bits may be converted to a predetermined base number (e.g., base 10, base 4, hexadecimal). In one example, leading zeroes are inserted or retained regardless of the level of the map tile grid in order to maintain a constant length for the one-dimensional array of the quadkey. In another example, the length of the one-dimensional array of the quadkey may indicate the corresponding level within the map tile grid. In one embodiment, the quadkey is an example of the hash or encoding scheme of the respective geographical coordinates of a geographical data point that can be used to identify a tile in which the geographical data point is located.

In exemplary embodiments, the road segment data records 605 are links or segments representing roads, streets, or paths, as can be used in the calculated route or recorded route information for determination of one or more personalized routes, according to exemplary embodiments. The node data records 603 are end points or vertices (such as intersections) corresponding to the respective links or segments of the road segment data records 605. The road segment data records 605 and the node data records 603 represent a road network, such as used by vehicles, cars, and/or other entities. Alternatively, the geographic database 107 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 107 can include data about the POIs and their respective locations in the POI data records 607. In one example, the POI data records 607 may include the hours of operation for various businesses. The geographic database 107 can also include data about places, such as cities, towns, or other communities, and other geographic features, such as bodies of water, mountain ranges, etc. Such place or feature data can be part of the POI data records 607 or can be associated with POIs or POI data records 607 (such as a data point used for displaying or representing a position of a city).

In one embodiment, other data records 609 include cartographic (“carto”) data records, routing data, weather data, and maneuver data. In one example, the other data records 609 include data that is associated with certain POIs, roads, or geographic areas. In one example, the data is stored for utilization by a third-party. In one embodiment, the other data records 609 include traffic data records such as traffic data reports. In one example, the traffic data reports are based on historical data. In another example, the traffic data reports are based on real-time traffic data reports. In one embodiment, the other data records 609 include event data. In one example, the event data includes information about upcoming events such as start time, end time, impact to access to one or more road segments, etc. In one example, the event data includes transit data such as train or bus schedules. In one embodiment, the other data records 609 include weather data records such as weather data reports. For example, the weather data records can be associated with any of the map features stored in the geographic database 107 (e.g., a specific road or link, node, intersection, area, POI, etc.) on which the weather data was collected. In another example, the other data records 609 can be associated with crosswalk information, traffic light times, traffic light signals, etc. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, the geographic database 107 may also include point data records for storing the point data, map features, as well as other related data used according to the various embodiments described herein. In addition, the point data records can also store ground truth training and evaluation data, machine learning models, annotated observations, and/or any other data. By way of example, the point data records can be associated with one or more of the node data records 603, road segment data records 605, and/or POI data records 607 to support verification, localization or visual odometry based on the features stored therein and the corresponding estimated quality of the features. In this way, the point data records can also be associated with or used to classify the characteristics or metadata of the corresponding records 603, 605, and/or 607.

As discussed above, the HD data records 611 may include models of road surfaces and other map features to centimeter-level or better accuracy. The HD data records 611 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD data records 611 may be divided into spatial partitions of varying sizes to provide HD mapping data to vehicles and other end user devices with near real-time speed without overloading the available resources of these vehicles and devices (e.g., computational, memory, bandwidth, etc. resources). In some implementations, the HD data records 611 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD data records 611.

In one embodiment, the HD data records 611 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The indexes 613 in FIG. 6 may be used improve the speed of data retrieval operations in the geographic database 107. Specifically, the indexes 613 may be used to quickly locate data without having to search every row in the geographic database 107 every time it is accessed. For example, in one embodiment, the indexes 613 can be a spatial index of the polygon points associated with stored feature polygons.

The geographic database 107 can be maintained by the one or more content providers 111a-111n in association with the services platform 113 (e.g., a map developer). The map developer can collect geographic data to generate and enhance the geographic database 107. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 107 can be a master geographic database stored in a format that facilitates updating, maintenance, and development. For example, the master geographic database 107 or data in the master geographic database 107 can be in an Oracle spatial format or other spatial format (for example, accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

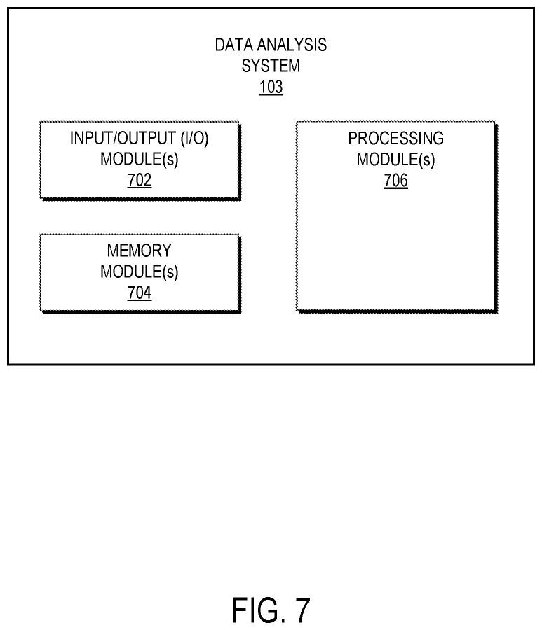

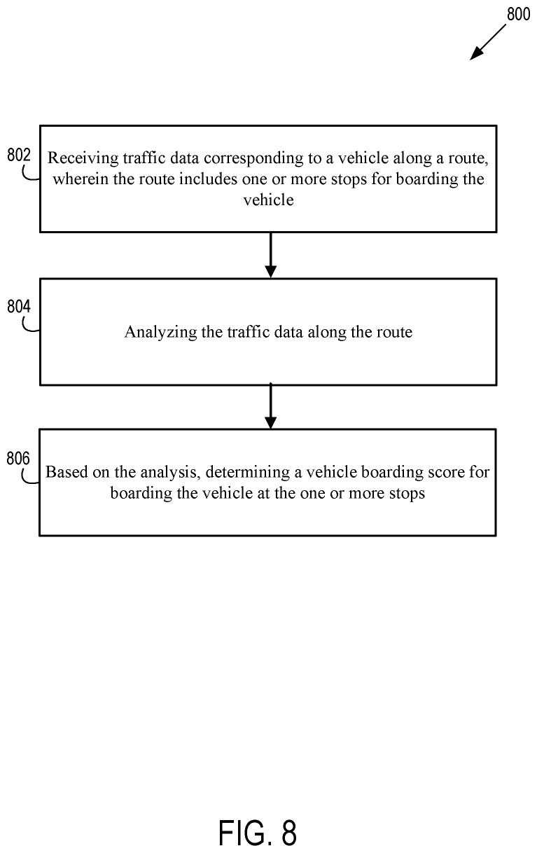

FIG. 7 is a diagram of the components of the data analysis system 103 of FIG. 1, according to one embodiment. By way of example, the data analysis system 103 includes one or more components for determining a vehicle boarding score according to the various embodiments described herein. It is contemplated that the functions of these components may be combined or performed by other components of equivalent functionality. In this embodiment, data analysis system 103 includes in input/output module 702, a memory module 704, and a processing module 706. The above presented modules and components of the data analysis system 103 can be implemented in hardware, firmware, software, or a combination thereof. Though depicted as a separate entity in FIG. 1, it is contemplated that the data analysis system 103 may be implemented as a module of any of the components of the system 100 (e.g., a component of the services platform 113, etc.). In another embodiment, one or more of the modules 702-706 may be implemented as a cloud-based service, local service, native application, or combination thereof. The functions of these modules are discussed with respect to FIGS. 8, 9, and 10 below.

FIGS. 8, 9, and 10 are flowcharts of example methods, each in accordance with at least some of the embodiments described herein. Although the blocks in each figure are illustrated in a sequential order, the blocks may in some instances be performed in parallel, and/or in a different order than those described therein. Also, the various blocks may be combined into fewer blocks, divided into additional blocks, and/or removed based upon the desired implementation.

In addition, the flowcharts of FIGS. 8, 9, and 10 each show the functionality and operation of one possible implementation of the present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer-readable media that stores data for short periods of time, such as register memory, processor cache, or Random Access Memory (RAM), and/or persistent long term storage, such as read only memory (ROM), optical or magnetic disks, or compact-disc read only memory (CD-ROM), for example. The computer readable media may also be, or include, any other volatile or non-volatile storage systems. The computer readable medium may be considered a computer readable storage medium, a tangible storage device, or other article of manufacture, for example.

Alternatively, each block in FIGS. 8, 9, and 10 may represent circuitry that is wired to perform the specific logical functions in the process. Illustrative methods, such as those shown in FIGS. 8, 9, and 10, may be carried out in whole or in part by a component or components in the cloud and/or system. However, it should be understood that the example methods may instead be carried out by other entities or combinations of entities (i.e., by other computing devices and/or combinations of computing devices), without departing from the scope of the invention. For example, functions of the method of FIGS. 8, 9, and 10 may be fully performed by a computing device (or components of a computing device such as one or more processors) or may be distributed across multiple components of the computing device, across multiple computing devices, and/or across a server.

Referring first to FIG. 8, an example method 800 may include one or more operations, functions, or actions as illustrated by blocks 802-806. The blocks 802-806 may be repeated periodically or performed intermittently, or as prompted by a user, device, or system. In one embodiment, the method 800 is implemented in whole or in part by the data analysis system 103 of FIG. 7.

As shown by block 802, the method 800 includes receiving traffic data corresponding to a vehicle along a route, wherein the route includes one or more stops for boarding the vehicle. In one example, the input/output module 702 of FIG. 7 is configured to receive traffic data corresponding to a vehicle along a route. In one example, the route includes one or more stops for boarding the vehicle. For example, the one or more stops may correspond to stops for boarding a bus or a train. In one example, the traffic data may be based on historical traffic data, real-time traffic data, or a combination thereof.

As shown by block 804, the method 800 also includes analyzing the traffic data along the route. In one example, the processing module 706 of FIG. 7 is configured to analyze the traffic data along the route. In one example, the analysis of the traffic data may include determining an average speed of other vehicles traveling along a route. In another example, the analysis of the traffic data may include determining other vehicles that are not traveling along the route but that may have an impact. For example, the analysis may include determining the schedules of one or more trains and the types of trains that have tracks that cross the route of a bus. In another example, the analysis of the traffic data my include determining traffic patterns that are associated with various points of interest (e.g., schools, businesses, sports stadiums) in an area.

As shown by block 806, the method 800 also includes based on the analysis, determining a vehicle boarding score for boarding the vehicle at the one or more stops. In one example, the analysis is based on a current location of the of the individual and how fast the individual is moving. In one scenario, an individual may be travelling by vehicle to board a train at a particular train stop. In this scenario, information about the vehicle that the individual is currently in may be analyzed to determine a vehicle boarding score. For example, the analysis may include an analysis of traffic data, route data, weather data, or a combination thereof associated with the current vehicle that the individual is travelling in to reach the train. In one example, the processing module 706 of FIG. 7 is configured to, based on the analysis, determine a vehicle boarding score for boarding the vehicle at the one or more stops. In one embodiment, the method 800 also includes, based on the vehicle boarding score, providing an instruction for operation of a vehicle along a route. In one example, the instruction may be an instruction to depart a later time from a given stop based on traffic conditions along the route. In another example, the instruction for the vehicle may be an instruction to depart at an earlier time from a particular stop.

In one embodiment, the method 800 also includes providing an instruction for displaying the vehicle boarding score. In one example, processing module 706 of FIG. 7 provides an instruction for displaying the vehicle boarding score via the input/output module 702 of FIG. 7. In one example, the vehicle boarding score is displayed via a display screen associated with a computing device coupled to a bus or a train. In another example, the vehicle boarding score is displayed on a mobile device (e.g., UE 109) assorted with an individual that is attempting to board the vehicle.

In another embodiment, the method 800 also includes receiving map data corresponding to a mobile device and the one or more stops for boarding the vehicle. In this embodiment, the method 800 also includes based on an analysis of the map data, modifying the vehicle boarding score. In one example, the map data includes a current location of the mobile device. In another example, the map data includes a current location of the mobile device and one or more map elements for determining a route or path that the individual may use to reach a stop for boarding a vehicle. In one example, the processing module 706 of FIG. 7 may be configured to determine that the one or more map elements (e.g., traffic lights, length of an intersection, number of crosswalks, etc.) decrease a likelihood that an individual can reach a stop for boarding the vehicle prior to a scheduled stop of the vehicle. In this example, the processing module 706 of FIG. 7 may be configured to lower the vehicle boarding score according to the decrease in likelihood that the individual can reach the stop for boarding the vehicle prior to the scheduled departure time of the vehicle at that the stop.

In another embodiment, the vehicle is an autonomous vehicle and the method 800 also includes determining a departure time corresponding to at least one stop of the one or more stops based on the vehicle boarding score. In this embodiment, the method 800 also providing an instruction for operation of the autonomous vehicle based on the departure time. In one example, the processing module 706 of FIG. 7 is configured to determine the departure time corresponding to at least one stop of the one or more stops based on the vehicle boarding score. For example, the processing module 706 may modify the time that the autonomous vehicle departs from a particular stop based on the vehicle boarding score. In one example, the autonomous vehicle may receive the modification to the departure time and adjust one or more aspects of operation. For example, the autonomous vehicle may drive at a slower speed as the autonomous vehicle approaches a stop that is associated with a high vehicle boarding score.

In one embodiment, the method 800 also includes receiving weather data associated with the vehicle. In this embodiment, the method 800 also includes based on analysis of the weather data, modifying the vehicle boarding score. In one example, the weather data may include weather data reports at various times throughout the day. In one example, the processing module 706 of FIG. 7 is configured to utilize the weather data and modify the vehicle boarding score accordingly. In one example, the processing module 706 of FIG. 7 is configured to determine that that the vehicle will be delayed due to weather conditions associated with a route of the vehicle based on the weather data. In this example, the processing module of FIG. 7 may be configured to modify the vehicle boarding score to reflect the delays due to the weather conditions.

In another embodiment, the method 800 also includes receiving movement data corresponding to a mobile device. In this embodiment, the method 800 also includes based on an analysis of the movement data, modifying the vehicle boarding score. In one example, the processing module 706 of FIG. 7 is configured to receive movement data and determine how slow an individual is moving towards a stop for boarding a vehicle. In this example, the processing module 706, based on the determined speed, may determine that the individual will most likely not reach a stop for boarding the vehicle prior to the vehicle departing from that stop and thus lower the vehicle boarding score.

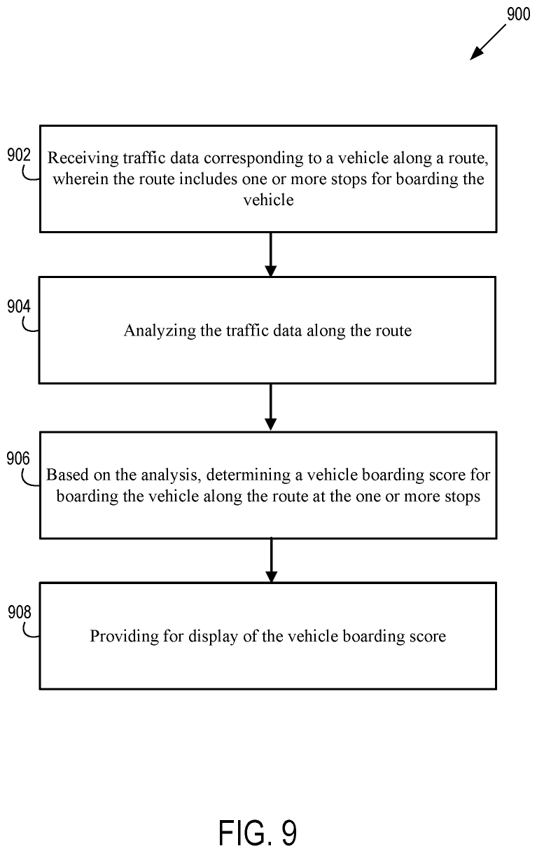

Referring to FIG. 9, the example method 900 may include one or more operations, functions, or actions as illustrated by blocks 902-908. The blocks 902-908 may be repeated periodically or performed intermittently, or as prompted by a user, device, or system. In one embodiment, the method 900 is implemented in whole or in part by the data analysis system 103 of FIG. 7.

As shown by block 902, the method 900 includes receiving traffic data corresponding to a vehicle along a route, wherein the route includes one or more stops for boarding the vehicle. In one example, the processing module 706 of FIG. 7 is configured to receive, via the input/output module 702 of FIG. 7, traffic data corresponding to a vehicle along a route. In one example, the traffic data may be based on historical traffic data, real-time traffic data, or a combination thereof.

As shown by block 904, the method 900 also includes analyzing the traffic data along the route. In one example, the processing module 706 of FIG. 7 is configured to analyze the traffic data along the route. Block 904 may be similar in functionality to block 804 of the method 800.

As shown by block 906, the method 900 also includes based on the analysis, determining a vehicle boarding score for boarding the vehicle along the route at the one or more stops. In one example, the processing module 706 of FIG. 7 is configured to, based on the analysis, determine a vehicle boarding score for boarding the vehicle along the route at the one or more stops. Block 906 may be similar in functionality to block 806 of the method 800.

As shown by block 908, the method 900 also includes providing for display of the vehicle boarding score. In one example, the processing module 706 of FIG. 7 is configured to display the vehicle boarding score or provide or enable the display of the vehicle boarding score. In one embodiment, the method 900 also includes based on the vehicle boarding score, providing an instruction for operation of a vehicle along a route. In one example, the vehicle boarding score is displayed on a user-interface that is part of an application (e.g., application(s) 117 of FIG. 1) on a portable electronic device (e.g., UE 109 of FIG. 1). In another example, the vehicle boarding score is displayed on a user-interface that is part of an application on an electronic device that is coupled to a public transport vehicle.

In one embodiment, the vehicle is an autonomous vehicle and the method 900 also includes determining a departure time based on the vehicle boarding score. In this embodiment, the method 900 also includes providing an instruction to the autonomous vehicle based on the departure time. In one example, the processing module 706 of FIG. 7 is configured to determine a departure time based on the vehicle boarding score. In this example, the processing module 706 may be configured to, via the input/output module 702 of FIG. 7, to provide an instruction to the autonomous vehicle based on the departure time.

In another embodiment, the method 900 also includes receiving weather data associated with the vehicle. In this embodiment, the method 900 also includes based on an analysis of the weather data, modifying the vehicle boarding score. In one example, the processing module 706 of FIG. 7 is configured to receive, via the input/output module 702 of FIG. 7, weather data associated with the vehicle. In this example, the processing module 706 of FIG. 7 is configured to, based on an analysis of the weather data, modify the vehicle boarding score.

In one embodiment, the method 900 also includes receiving movement data associated with a mobile device. In this embodiment, the method 900 also includes based on the analysis of the movement data, modifying the vehicle boarding score. Continuing with this embodiment, based on the modification to the vehicle boarding score, providing for display, via the display screen, a visual effect associated with the modification. In one example, the visual effect may be an effect associated with a change from one color to another color. In one scenario, a high vehicle boarding score may be displayed with the color green. In this scenario, a low vehicle boarding score may be displayed with the color red. In one example, the visual effect may cause a display to begin flashing if the score is changing from high to low. In another example, the visual effect may be provided as an overlay via an application of a mobile device. In one example, the processing module 706 of FIG. 7 is configured to receive, via the input/output module 702 of FIG. 7, movement data associated with a mobile device. In this example, the processing module 706 of FIG. 7 is configured to, based on the analysis of the movement data, modify the vehicle boarding score.

In another embodiment, the method 900 also includes receiving map data associated with the mobile device. In this embodiment, the method 900 also includes based on an analysis of the map data, modifying the vehicle boarding score. Continuing with this embodiment, based on the modification to the vehicle boarding score, providing for display, via the display screen, a visual effect associated with the modification. In one example, the processing module 706 of FIG. 7 is configured to receive, via the input/output module 702 of FIG. 7, map data associated with the mobile device. In this example, the processing module 706 of FIG. 7 is configured to, based on an analysis of the map data, modify the vehicle boarding score.

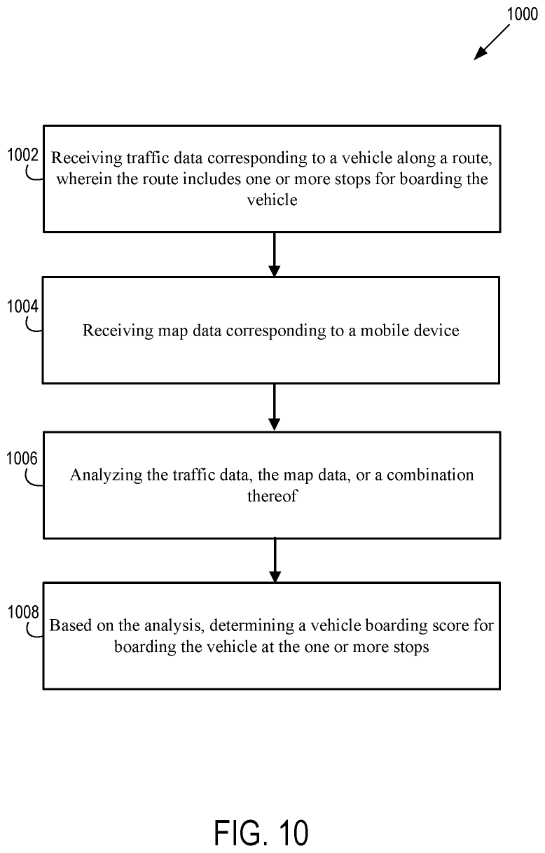

Referring to FIG. 10, the example method 1000 may include one or more operations, functions, or actions as illustrated by blocks 1002-1008. The blocks 1002-1008 may be repeated periodically or performed intermittently, or as prompted by a user, device, or system. In one embodiment, the method 1000 is implemented in whole or in part by the data analysis system 103 of FIG. 7.

As shown by block 1002, the method 1000 includes receiving traffic data corresponding to a vehicle along a route, wherein the route includes one or more stops for boarding the vehicle. In one example, the processing module 706 of FIG. 7 is configured to receive traffic data corresponding to a vehicle along a route.

As shown by block 1004, the method 1000 also includes receiving map data corresponding to a mobile device. In one example, the processing module 706 of FIG. 7 is configured to receive map data corresponding to a mobile device. In one example, the map data includes a current location of the mobile device. In another example, the map data includes a current location of the mobile device and one or more map elements for determining a route or path that the individual may use to reach a stop for boarding a vehicle.

As shown by block 1006, the method 1000 also includes analyzing the traffic data, the map data, or a combination thereof. In one example, the processing module 706 of FIG. 7 is configured to analyze the traffic data, the map data, or a combination thereof. In one example, the analysis of the traffic data includes an analysis of the traffic along the route of the vehicle. In another example, the analysis of the traffic data includes an analysis of traffic data associated with the individual attempting to reach the stop for boarding the vehicle. In another example, the analysis of the map data includes an analysis of the one or more map elements associated with a stop for boarding the vehicle. In another example, the analysis of the map data includes an analysis of one or more map elements associated with a current location of the individual. In one example, the analysis of the map data includes an analysis of one or more map elements associated with an expected location of the individual.

As shown by block 1008, the method 1000 also includes based on the analysis, determining a vehicle boarding score for boarding the vehicle at the one or more stops. In one example, the processing module 706 of FIG. 7 is configured to, based on the analysis, determine a vehicle boarding score for boarding the vehicle at the one or more stops. In one embodiment, the method 1000 also includes providing an instruction for operating the vehicle based on the vehicle boarding score. In one example, the vehicle boarding score may be based on a numerical range. For example, the vehicle boarding score may be based on a value between 0 and 1. In this example, a vehicle boarding score of 0 would indicate that an individual will not reach the stop for boarding the vehicle in time and a vehicle boarding score of 1 would indicate the induvial will reach the stop for boarding the vehicle in time. In one example, the scores that are within 0 to 1 (e.g., 0.1, 0.2, 0.3, etc.) could be used to determine the likelihood that an individual will be on time at a stop to board the vehicle. For a example, a score of 0.1 would be associated with a lower likelihood than a score of 0.3.

In one embodiment, the method 1000 also includes determining a departure time based on the vehicle boarding score. In this embodiment, the method 1000 also includes providing an instruction to the autonomous vehicle based on the departure time. In one example, the processing module 706 of FIG. 7 is configured to determine a departure time based on the vehicle boarding score. In this example, the processing module 706 may be configured to, via the input/output module 702 of FIG. 7, to provide an instruction to the autonomous vehicle based on the departure time.

In another embodiment, the method 1000 also includes receiving weather data associated with the vehicle. In this embodiment, the method 1000 also includes, based on an analysis of the weather data, modifying the vehicle boarding score. In one example, the processing module 706 of FIG. 7 is configured to receive, via the input/output module 702 of FIG. 7, weather data associated with the vehicle. In this example, the processing module 706 of FIG. 7 is configured to, based on an analysis of the weather data, modify the vehicle boarding score.

In one embodiment, the method 1000 also includes receiving movement data associated with the mobile device. In this embodiment, the method 1000 also includes, based on an analysis of the movement data, modifying the vehicle boarding score. In one example, the processing module 706 of FIG. 7 is configured to receive, via the input/output module 702 of FIG. 7, movement data associated with a mobile device. In this example, the processing module 706 of FIG. 7 is configured to, based on the analysis of the movement data, modify the vehicle boarding score.

The processes described herein for determining a vehicle boarding score may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

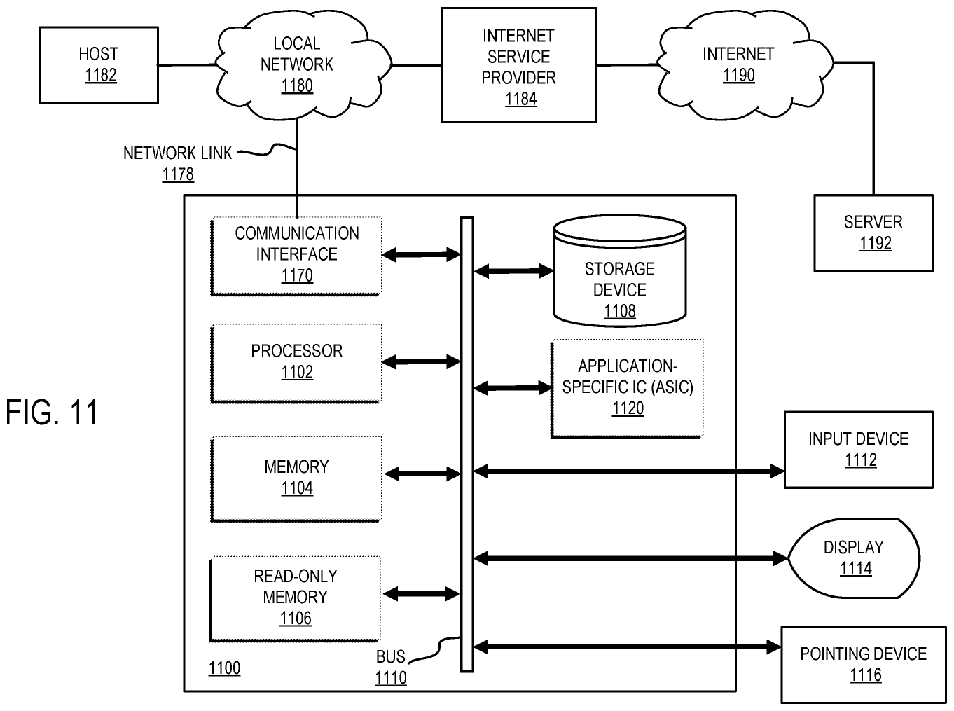

FIG. 11 illustrates a computer system 1100 upon which an embodiment may be implemented. Computer system 1100 is programmed (e.g., via computer program code or instructions) to provide information for determining a vehicle boarding score as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to determining a vehicle boarding score. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random-access memory (RAM) or other dynamic storage device, stores information including processor instructions for determining a vehicle boarding score. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for determining a vehicle boarding score, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in the computer system 1100. Other external devices coupled to bus 1110, used primarily for interacting with humans, include a display 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 may also include one or more instances of a communications interface 1170 coupled to bus 1110. The communication interface 1170 may provide a one-way or two-way communication coupling to a variety of external devices that operate with their own processors, such as printers, scanners and external disks. In addition, the communication interface 1170 may provide a coupling to a local network 1180, by way of a network link 1178. The local network 1180 may provide access to a variety of external devices and systems, each having their own processors and other hardware. For example, the local network 1180 may provide access to a host 1182, or an internet service provider 1184, or both, as shown in FIG. 11. The internet service provider 1184 may then provide access to the Internet 1190, in communication with various other servers 1192.

The computer system 1100 also includes one or more instances of a communication interface 1170 coupled to bus 1110. Communication interface 1170 provides a one-way or two-way communication coupling to a variety of external devices that operate with their own processors, such as printers, scanners and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, the communication interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, the communication interface 1170 may be a local area network (LAN) card to provide a data communication connection to a compatible LAN, such as Ethernet. Wireless links may also be implemented. For wireless links, the communication interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 1170 enables connection to the communication network 115 of FIG. 1 for providing information for determining a vehicle boarding score.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

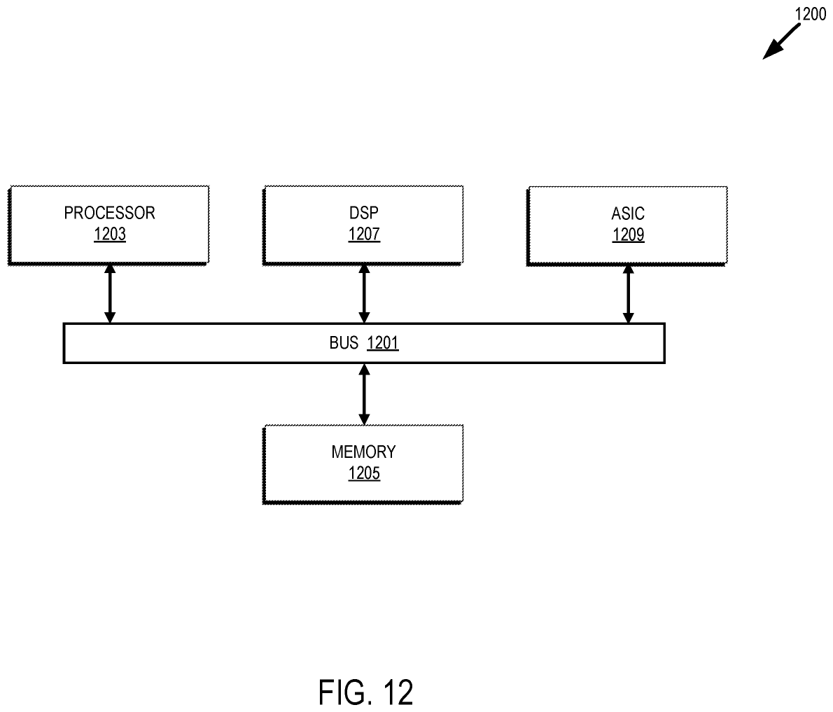

FIG. 12 illustrates a chip set 1200 upon which an embodiment may be implemented. The chip set 1200 is programmed to determine a vehicle boarding score as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the steps described herein to provide information for determining a vehicle boarding score. The memory 1205 also stores the data associated with or generated by the execution of the inventive steps.

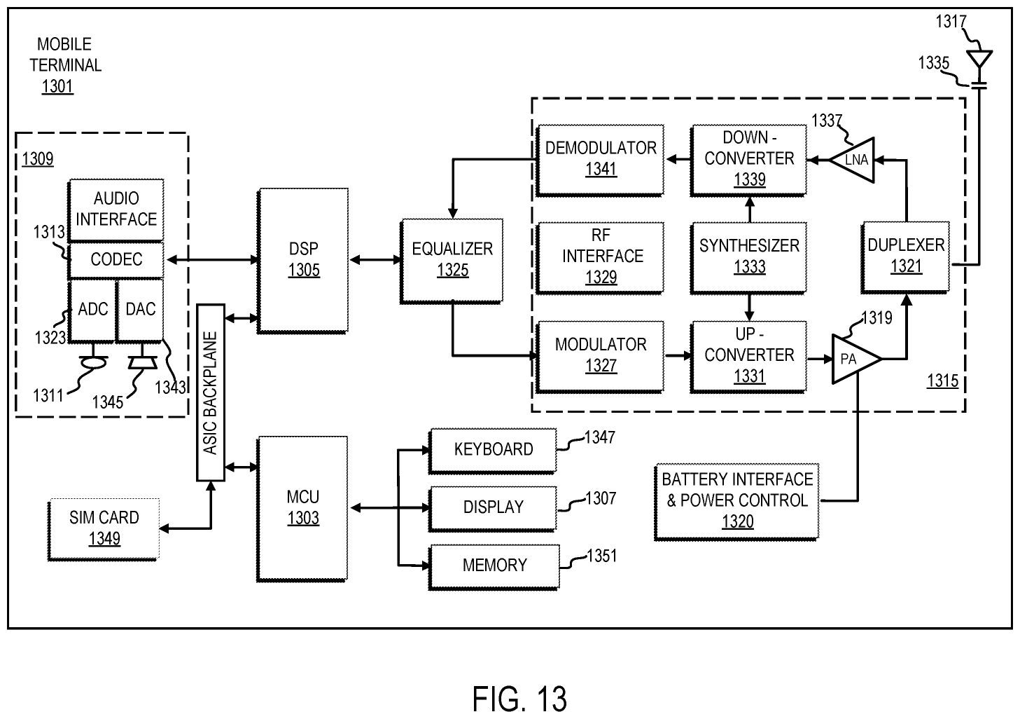

FIG. 13 is a diagram of exemplary components of a mobile terminal 1301 (e.g., a mobile device, vehicle, and/or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide information for determining a vehicle boarding score. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The SIM card 1349 also contains a memory for storing a personal telephone number registry, text messages, and user specific mobile station settings.

While features have been described in connection with a number of embodiments and implementations, various obvious modifications and equivalent arrangements, which fall within the purview of the appended claims are envisioned. Although features are expressed in certain combinations among the claims, it is contemplated that these features can be arranged in any combination and order.

We (I) claim:

1. A method for determining a vehicle boarding score, the method comprising:
receiving traffic data corresponding to a vehicle along a route, wherein the route includes one or more stops for boarding the vehicle;
analyzing the traffic data along the route; and
based on the analysis, determining a vehicle boarding score for boarding the vehicle at the one or more stops.

2. The method of claim 1, further comprising:
providing an instruction for displaying the vehicle boarding score.

3. The method of claim 1, further comprising:
receiving map data corresponding to a mobile device and the one or more stops for boarding the vehicle; and
based on an analysis of the map data, modifying the vehicle boarding score.

4. The method of claim 1, wherein the vehicle is an autonomous vehicle, the method further comprising:
determining a departure time corresponding to at least one stop of the one or more stops based on the vehicle boarding score; and
providing an instruction for operation of the autonomous vehicle based on the departure time.

5. The method of claim 1, further comprising:
receiving weather data associated with the vehicle; and
based on analysis of the weather data, modifying the vehicle boarding score.

6. The method of claim 1, further comprising:
receiving movement data corresponding to a mobile device; and
based on an analysis of the movement data, modifying the vehicle boarding score.

7. The method of claim 1, further comprising:
based on the vehicle boarding score, providing an instruction for operation of a vehicle along a route.

8. A non-transitory computer-readable storage medium comprising one or more sequences of one or more instructions for execution by one or more processors of a device with a display screen and one or more input devices, the one or more instructions which, when executed by the one or more processors, cause the device to:
receive traffic data corresponding to a vehicle along a route, wherein the route includes one or more stops for boarding the vehicle;
analyze the traffic data along the route; and
based on the analysis, determine a vehicle boarding score for boarding the vehicle along the route at the one or more stops; and
provide for display, via the display screen, the vehicle boarding score.

9. The non-transitory computer-readable storage medium of claim 8, wherein the one or more instructions which, when executed by the one or more processors, further cause the device to:
receive movement data associated with a mobile device;
based on the analysis of the movement data, modify the vehicle boarding score.

10. The non-transitory computer-readable storage medium of claim 9, wherein the one or more instructions which, when executed by the one or more processors, further cause the device to:
based on the modification to the vehicle boarding score, provide for display, via the display screen, a visual effect associated with the modification.

11. The non-transitory computer-readable storage medium of claim 8, wherein the one or more instructions which, when executed by the one or more processors, further cause the device to:
based on the vehicle boarding score, provide an instruction for operation of a vehicle along a route.

12. The non-transitory computer-readable storage medium of claim 8, wherein the vehicle is an autonomous vehicle, wherein the one or more instructions which, when executed by the one or more processors, further cause the device to:
determine a departure time based on the vehicle boarding score; and
provide an instruction to the autonomous vehicle based on the departure time.

13. The non-transitory computer-readable storage medium of claim 8, wherein the one or more instructions which, when executed by the one or more processors, further cause the device to:
receive weather data associated with the vehicle; and
based on an analysis of the weather data, modify the vehicle boarding score.

14. The non-transitory computer-readable storage medium of claim 8, wherein the one or more instructions which, when executed by the one or more processors, further cause the device to:
receive map data associated with the mobile device; and
based on an analysis of the map data, modify the vehicle boarding score.

15. The non-transitory computer-readable storage medium of claim 14, wherein the one or more instructions which, when executed by the one or more processors, further cause the device to:
based on the modification to the vehicle boarding score, provide for display, via the display screen, a visual effect associated with the modification.

16. An apparatus for determining a vehicle boarding score, the apparatus comprising:
a processor; and
a memory comprising computer program code for one or more programs, wherein the computer program code is configured to cause the processor of the apparatus to:
receive traffic data corresponding to a vehicle along a route, wherein the route includes one or more stops for boarding the vehicle;
receive map data corresponding to a mobile device;
analyze the traffic data, the map data, or a combination thereof; and
based on the analysis, determine a vehicle boarding score for boarding the vehicle at the one or more stops.

17. The apparatus of claim 16, wherein the computer program code is configured to further cause the processor of the apparatus to:
provide an instruction for operating the vehicle based on the vehicle boarding score.

18. The apparatus of claim 16, wherein the vehicle is an autonomous vehicle, wherein the computer program code is configured to further cause the processor of the apparatus to:
determine a departure time based on the vehicle boarding score; and
provide an instruction to the autonomous vehicle based on the departure time.

19. The apparatus of claim 16, wherein the computer program code is configured to further cause the processor of the apparatus to:
receive weather data associated with the vehicle; and
based on an analysis of the weather data, modify the vehicle boarding score.

20. The apparatus of claim 16, wherein the computer program code is configured to further cause the processor of the apparatus to:
receive movement data associated with the mobile device; and
based on an analysis of the movement data, modify the vehicle boarding score.
